(19) United States
(12) Patent Application Publication
(10) Pub. No.: US 2018/0231805 A1
(43) Pub. Date: Aug. 16, 2018

(54) SUBSTRATE, SEALING STRUCTURE OF DISPLAY PANEL, DISPLAY PANEL, AND DISPLAY APPARATUS

(71) Applicants: BOE Technology Group Co., Ltd., Beijing (CN); Ordos Yuansheng Optoelectronics Co., Ltd., Ordos (CN)

(72) Inventors: Feng Yang, Beijing (CN); Tinglai Lu, Beijing (CN); Weixin Meng, Beijing (CN); Qiang Chen, Beijing (CN); Fang Zhu, Beijing (CN)

(73) Assignees: BOE TECHNOLOGY GROUP CO., LTD.; ORDOS YUANSHENG OPTOELECTRONICS CO., LTD.

(21) Appl. No.: 15/828,502

(22) Filed: Dec. 1, 2017

(30) Foreign Application Priority Data
Feb. 13, 2017 (CN) 201720128172.6

(51) Int. Cl. G02F 1/01; G02F 1/1333

(52) U.S. Cl. CPC G02F 1/0107; G02F 1/133308

(57) ABSTRACT

The present disclosure relates to a substrate, a sealing structure of a display panel, a display panel and a display apparatus, in the field of display. The substrate comprises a display area and a non-display area, wherein the non-display area is provided with a first sealing component; the first sealing component comprises a groove arranged surrounding the display area, and a width of a bottom of the groove is greater than a width of an opening of the groove. Alternatively, the substrate comprises a display area and a non-display area, wherein the non-display area is provided with a second sealing component, and the second sealing component is arranged surrounding the display area; A width of a top of the second sealing component is greater than a width of a bottom of the second sealing component, and the bottom of the second sealing component is closer to the non-display area than the top of the second sealing component is. The present disclosure may improve the binding strength between the two substrates, prevent the liquid crystal from being polluted and prevent the liquid crystal puncture from arising.

This application claims priority to Chinese Application No. 201720128172.6, filed with the State Intellectual Property Office on Feb. 13, 2017 and titled “SUBSTRATE, SEALING STRUCTURE OF DISPLAY PANEL, DISPLAY PANEL AND DISPLAY APPARATUS,” the entire contents of which are incorporated herein by reference.

### TECHNICAL FIELD

The present disclosure relates to the field of display, and more particularly to a substrate, a sealing structure of a display panel, a display panel, and a display apparatus.

### BACKGROUND

A liquid crystal display (LCD) panel usually comprises an upper substrate, a lower substrate, and a liquid crystal disposed between the two layers of the substrates. A sealing structure is arranged on the edge of the two substrates. The two substrates adhere to each other through the sealing structure. The two substrates and the sealing structure form a sealing and the liquid crystal is sealed in the sealing space.

At present, the material of the sealing structure is frame sealant. When a LCD panel is manufactured, the periphery around the lower substrate is first coated with the frame sealant whose cross section is rectangle-shaped; before the frame sealant solidifies, the liquid crystal is instilled onto the lower substrate; after the liquid crystal diffuses evenly throughout the lower substrate, the upper substrate and the lower substrate are assembled and adhered to each other with the unsolidified frame sealant to form the LCD panel.

### SUMMARY

In order to solve the problem in the related art, embodiment of the present disclosure provides a substrate, a sealing structure of a display panel, a display panel and a display apparatus.

In a first aspect, the present disclosure provides a substrate. The substrate comprises a display area and a non-display area. The non-display area is provided with a first sealing component;

the first sealing component comprises a groove arranged surrounding the display area, and a width of a bottom of the groove is greater than a width of an opening of the groove.

In some embodiments, a sidewall of the groove is of an arc structure or an inclined plane structure.

In some embodiments, a material of the first sealing component is a soft material.

In some embodiments, the first sealing component comprises a square annular structure that is made up of four strip-shaped structures, a bottom surface of each strip-shaped structure is fixed on the non-display area of the substrate, each strip-shaped structure is provided with a strip-shaped groove, and the four strip-shaped grooves are communicated to form the groove.

In a second aspect, the present disclosure provides a substrate. The substrate comprises a display area and a non-display area. The non-display area is provided with a second sealing component, the second sealing component is arranged surrounding the display area;

a width of a top of the second sealing component is greater than a width of a bottom of the second sealing component, and the bottom of the second sealing component is closer to the non-display area than the top of the second sealing component is.

In some embodiments, a material of the second sealing component is a soft material.

In some embodiments, the second sealing component comprises a square annular structure that is made up of four strip-shaped structures and a bottom surface of each strip-shaped structure is fixed on the non-display area of the substrate.

In some embodiments, two side surfaces of the each strip-shaped structure are provided with protruding parts.

In some embodiments, a side of the protruding part that is away from the substrate is flush with a top surface of the strip-shaped structure.

In some embodiments, the display area is a square area, and a figure of an inner boundary of the square annular structure and a figure of an outer boundary of the display area are similar.

In some embodiments, a material of the protruding parts is a fusible soft material.

In some embodiments, two side surfaces of the second sealing component are of arc structures or inclined plane structures.

In a third aspect, the present disclosure provides a sealing structure of a display panel. The sealing structure comprises a first substrate and a second substrate. Both the first substrate and the second substrate are provided with display areas and non-display areas;

the non-display area of the first substrate is provided with a first sealing component;

the first sealing component comprises a groove arranged surrounding the display area of the first substrate, and a width of a bottom of the groove is greater than a width of an opening of the groove;

the non-display area of the second substrate is provided with a second sealing component, the second sealing component is arranged surrounding the display area of the second substrate;

a width of a top of the second sealing component is greater than a width of a bottom of the second sealing component, and the width of the top of the second sealing component is greater than the width of the opening of the groove, the bottom of the second sealing component is closer to the non-display area of the second substrate than the top of the second sealing component is; and

the second sealing component is embedded in the groove.

In some embodiments, a height of the second sealing component equals to a depth of the groove.

In some embodiments, the second sealing component is fuse bonded to a sidewall of the groove.

In some embodiments, the sealing structure further comprises a third sealing component. The third sealing component is arranged surrounding the display area of the second substrate; and

a width of the third sealing component equals to the width of the first sealing component, the third sealing component is fixed on the second substrate, and the second sealing component is fixed on the third sealing component.

In some embodiments, the width of the top of the groove is less than or equals to the width of the third sealing component.

In some embodiments, a material of the third sealing component is a soft material.

In a fourth aspect, the present disclosure provides a display panel. The display panel comprises the sealing structure provided in the third aspect.

In a fifth aspect, the present disclosure provides a display apparatus. The display apparatus comprises the display panel provided in the fourth aspect.

In the embodiments of the present disclosure, since the first sealing component comprises a groove arranged surrounding the display area, the width of the bottom of the groove is greater than the width of the opening of the groove, and the width of the top of the second sealing component is greater than the width of the bottom of the second sealing component, after the liquid crystal is instilled onto the substrate, the second sealing component can be embedded into the groove and the first substrate and the second substrate can be assembled. Since the first sealing component and the second sealing component fit with each other tightly through the method of embedding, the structure formed of the first sealing component and the second sealing component is not easy to be thrust and broken by the liquid crystal, thereby improving the bonding strength between the two substrates.

Additionally, the first sealing component and the second sealing component on the two substrates are of solid structures when they are in contact with the liquid crystal. Compared to the traditional colloidal structure, solid structure pollutes the liquid crystal less and the possibility of liquid crystal puncture is lower. Therefore, the liquid crystal pollution may be reduced and the liquid crystal puncture arises less.

It is to be understood that both the foregoing general description and the following detailed description are exemplary and explanatory only and are not restrictive of the present disclosure.

### BRIEF DESCRIPTION OF THE DRAWINGS

The accompanying drawings, which are incorporated in and constitute a part of this specification, illustrate embodiments consistent with the present disclosure and, together with the description, serve to explain the principles of the present disclosure.

FIG. 1 is a top view of a structure of a substrate provided in an embodiment of the present disclosure;

FIG. 2 is a partial sectional diagram of a substrate shown in FIG. 1;

FIG. 3 is a structural diagram of another substrate provided in an embodiment of the present disclosure;

FIG. 4 is a top view of a structure of another substrate provided in an embodiment of the present disclosure;

FIG. 5 is a partial sectional diagram of a substrate shown in FIG. 4;

FIG. 6 is a structural diagram of a further substrate provided in an embodiment of the present disclosure;

FIG. 7 is a structural diagram of a still further substrate provided in an embodiment of the present disclosure;

FIG. 8 is a structural diagram of a still further substrate provided in an embodiment of the present disclosure;

FIG. 9 is a diagram of a sealing structure of a display panel provided in an embodiment of the present disclosure;

FIG. 10 is a diagram of an assembly of a first substrate and a second substrate provided in an embodiment of the present disclosure;

FIG. 11 is a diagram of a sealing structure of another display panel provided in an embodiment of the present disclosure;

FIG. 12 is a diagram of a sealing structure of a further display panel provided in an embodiment of the present disclosure; and

FIG. 13 is a diagram of a sealing structure of a still further display panel provided in an embodiment of the present disclosure.

### DETAILED DESCRIPTION OF THE EMBODIMENTS

The present disclosure will be described in further detail with reference to the enclosed drawings, to clearly present the objects, technique solutions, and advantages of the present disclosure.

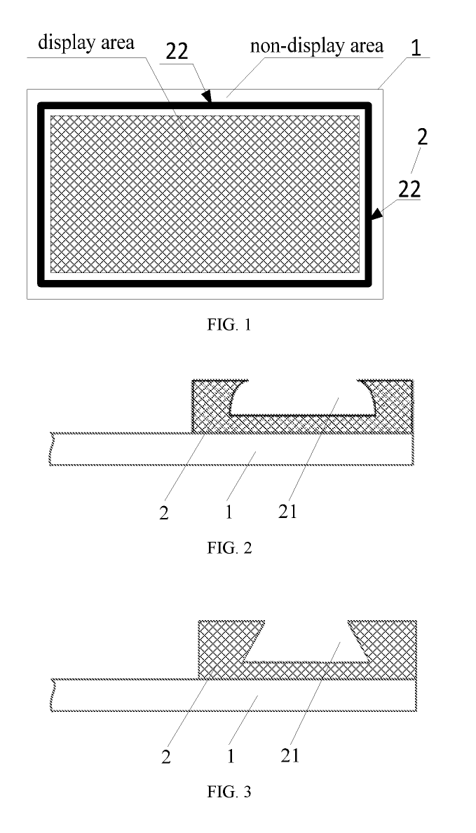

Referring to FIG. 1 and FIG. 2, FIG. 1 is a top view of a structure of a substrate provided in an embodiment of the present disclosure. FIG. 2 is a partial sectional diagram of a substrate shown in FIG. 1. For the convenience of illustration, the substrate is referred to as a first substrate 1. The structure on the first substrate 1 and the structure on a second substrate 3 provided in the embodiment described hereinafter may fit with each other to form a sealing structure of the display panel. The first substrate 1 may be an array substrate or a color filter substrate.

Referring to FIG. 1, the first substrate 1 includes a display area and a non-display area. The non-display area of the first substrate 1 may be the area near the side edge on the first substrate 3 surface. The non-display area surrounds the display area. Here, the display area is also referred to as the active area (AA) and the non-display area is the area out of the display area on the first substrate 1.

The non-display area of the first substrate 1 is provided with a first sealing component 2;

the first sealing component 2 includes a groove 21 arranged surrounding the display area (the groove 21 extends to form an enclosed annular structure, and the annular structure may be square or circular). Referring to FIG. 2, the width of the bottom of the groove 21 is greater than the width of the opening of the groove.

In some embodiments, referring to FIG. 1, the first sealing component 2 may comprise a square annular structure that is made up of four strip-shaped structures 22. A bottom surface of each strip-shaped structure 22 is fixed on the non-display area of the substrate 1. Each strip-shaped structure 22 is provided with a strip-shaped groove (not shown in FIG. 1), and four strip-shaped grooves are communicated to form the groove. Generally, the display area is a square area and a figure of an inner boundary of the square annular structure and a figure of an outer boundary of the display area are similar to match with the shape of the display area. In some embodiments, the distance between the inner boundary of the square annular structure and the outer boundary of the display area is usually between 150 micrometers and 300 micrometers.

Referring to FIG. 2, a sidewall of the groove 21 may be of an arc structure. Referring to FIG. 3, the sidewall of the groove 21 may also be of an inclined plane structure.

In some embodiments, a material of the first sealing component 2 is a soft material, which may reduce the damage to the first substrate.

Any type of the above first sealing component 2 may be manufactured with the colloid (for example, the traditional sealant material) that is formed of soft materials. In practice, the shape of the colloid outlet (i.e., the outlet where the colloid comes out) may be the shape of the cross section of the first sealing component 2 shown in FIG. 2 or FIG. 3. After the colloid outlet is disposed on the non-display area of the first substrate 1, the soft material colloid is coated surrounding the display area of the first substrate 1. Once the colloid solidifies, the first sealing component 2 is formed.

It is to be noted that during the solidification process of the colloid, the solidification process may be accelerated by way of heating (also referred to as drying).

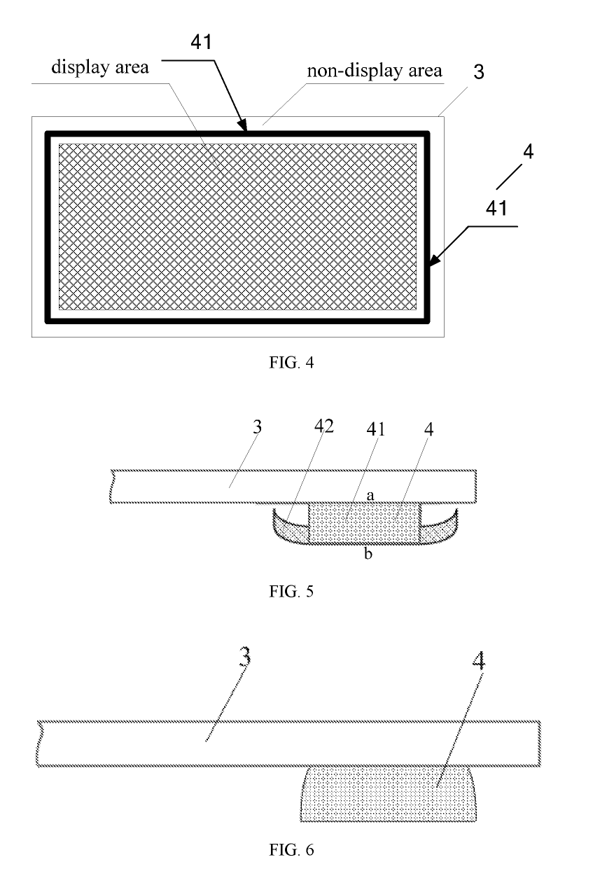

Referring to FIG. 4 and FIG. 5, FIG. 4 is a top view of a structure of a substrate in an embodiment of the present disclosure. FIG. 5 is a diagram of a partial section of the substrate shown in FIG. 4. For the convenience of illustration, the substrate is referred to as the second substrate 3. The structure on the second substrate 3 may fit with the structure on the first substrate 1 in the above embodiment to form the sealing structure of the display panel. The second substrate 3 may be an array substrate or a color filter substrate.

Referring to FIG. 4, the second substrate 3 includes a display area and a non-display area. The top view of the second substrate 3 is similar to that of the first substrate 1. The non-display area of the second substrate 3 may be the area near the side edge on the second substrate 3 surface. The non-display area surrounds the display area. Here, the display area is also referred to as an AA area and the non-display area is the area out of the display area on the first substrate.

The non-display area of the second substrate 3 is provided with a second sealing component 4. The second sealing component 4 is arranged surrounding the display area (the second sealing component 4 extends to form an enclosed annular structure and the annular structure may be square or circular). The bottom a of the second sealing component 4 is closer to the non-display area of the second substrate 3 than the top b of the second sealing component is;

the width of the top b of the second sealing component 4 is greater than the width of the bottom a of the second sealing component 4.

The material of the second sealing component 4 is a soft material. The soft material may reduce the damage to the second substrate.

In some embodiments, referring to FIG. 4, the second sealing component 4 comprises a square annular structure that is made up of four strip-shaped structures 41. The bottom surface of each strip-shaped structure 41 is fixed on the non-display area of the second substrate 3. As shown in FIG. 5, two side surfaces of each strip-shaped structure 41 are provided with protruding parts 42 and the side of the protruding part 42 away from the substrate 3 is flush with the top surface of the strip-shaped structure 41. Generally, the display area is a square area. The figure of the inner boundary of the square annular structure and the figure of the outer boundary of the display area are similar in order to match up with the shape of the display area. In some embodiments, the distance between the inner boundary of the square annular structure and the outer boundary of the display area is usually between 150 micrometers and 300 micrometers.

In some embodiments, the material of the protruding part 42 is a fusible soft material.

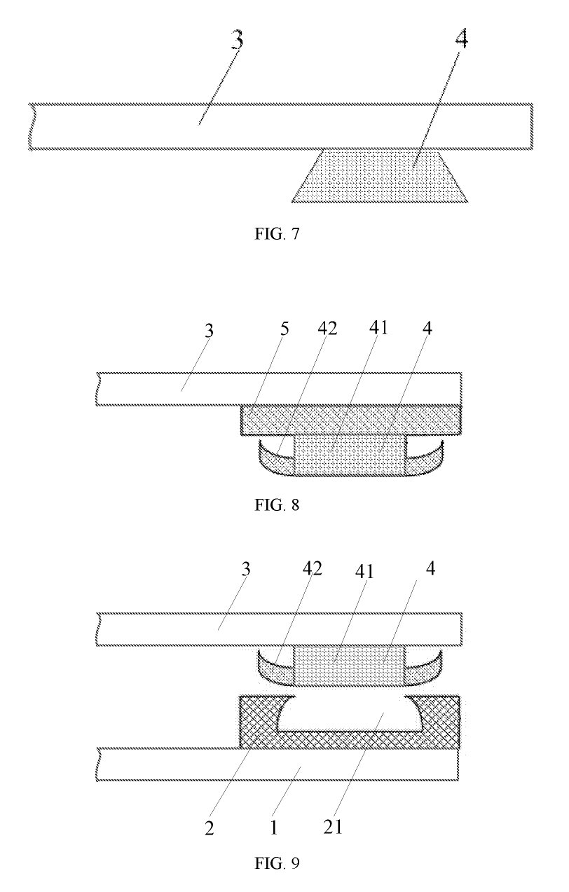

In some embodiments, the second sealing component 4 may also be of other structures apart from the structure shown in FIG. 5. For example, referring to FIG. 6, two side surfaces of the second sealing component 4 are of arc structures. Or, referring to FIG. 7, the two side surfaces of the second sealing component 4 are of inclined plane structures.

In some embodiments, referring to FIG. 8, the second substrate 3 is further provided a third sealing component 5. The third sealing component 5 is arranged surrounding the display area of the second substrate 3. The material of the third sealing component may be a soft material.

The width of the third sealing component 5 and the width of the second sealing component 4 are equal. The third sealing component 5 is fixed on the second substrate 3 and the second sealing component 4 is fixed on the third sealing component 5.

Any type of the above second sealing component 4 may be manufactured with the colloid (for example, the traditional sealant material) that is formed of soft materials. In practice, the shape of the colloid outlet (the outlet where the colloid comes out) may be the shape of the cross section of any one of the second sealing components 4 shown from FIG. 5 to FIG. 7. After the colloid outlet is disposed on the non-display area of the second substrate 3, the soft material colloid is coated surrounding the display area of the second substrate 3. Once the colloid solidifies, the second sealing component 4 is formed.

In some embodiments, the second sealing component 4 and the third sealing component 5 shown in FIG. 8 may be integrally manufactured with the colloid that is formed of soft materials. In practice, the shape of the colloid outlet may be the combined shape of the cross sections of the second sealing component 4 and the third sealing component shown in FIG. 8. After the colloid outlet is disposed on the non-display area of the second substrate 3, the soft material colloid is coated surrounding the display area of the second substrate 3. Once the colloid solidifies, the second sealing component 4 and the third sealing component 5 are formed.

It is to be noted that during the solidification process of the colloid, the solidification process may be accelerated by way of heating (also referred to as drying).

Referring to FIG. 9, the embodiments of the present disclosure provide a sealing structure of a display panel. The sealing structure comprises: any type of the first substrates 1 provided from FIG. 1 to FIG. 3 and any type of the second substrates 3 provided from FIG. 4 to FIG. 8. Here, the first substrate is an array substrate and the second substrate is a color filter substrate. Alternatively, the first substrate is a color filter substrate and the second substrate is an array substrate.

The non-display area of the first substrate 1 is provided with a first sealing component 2;

the first sealing component 2 comprises the groove 21 arranged surrounding the display area of the first substrate, and the width of the bottom of the groove 21 is greater than the width of the opening of the groove 21;

the non-display area of the second substrate 3 is provided with a second sealing component 4, and the second sealing component 4 is arranged surrounding the display area of the second substrate;

the width of the top of the second sealing component 4 is greater than the width of the bottom of the second sealing component 4, the width of the top of the second sealing component 4 is greater than the width of the opening of the groove 21, and the bottom of the second sealing component 4 is closer to the non-display area of the second substrate than the top of the second sealing component 4 is.

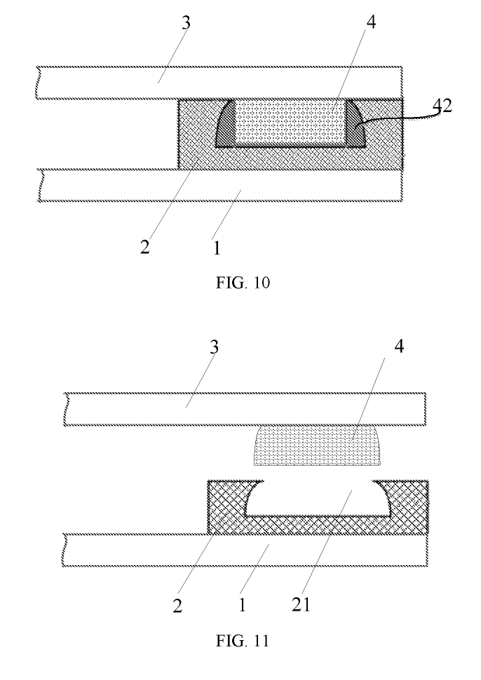

Referring to FIG. 10, the second sealing component 4 is embedded in the groove 21 to assembly the first substrate 1 with the second substrate 3.

In the embodiments of the present disclosure, since the first sealing component 2 is provided with the groove 21 therein, the width of the bottom of the groove 21 is greater than the width of the opening of the groove 21, and the width of the top of the second sealing component 4 is greater than the width of the bottom of the second sealing component 4, after the liquid crystal is instilled onto the substrate, the second sealing component 4 can be embedded into the groove 21 and the first substrate 1 and the second substrate 3 can be assembled. Since the first sealing component 2 and the second sealing component 4 fit with each other tightly through the method of embedding, the structure formed of the first sealing component 2 and the second sealing component 4 is not easy to be thrust and broken by the liquid crystal, thereby improving the bonding strength between the two substrates.

In the related art, the liquid crystal is instilled before the frame sealant solidifies, and therefore the phenomenon that the frame sealant pollutes the liquid crystal and the phenomenon of liquid crystal puncture are likely to arise.

In the embodiments of the present disclosure, the first sealing component and the second sealing component on the two substrates are of solid structures when they are in contact with the liquid crystal. Compared to the traditional colloidal structure, solid structure pollutes the liquid crystal less and the possibility of liquid crystal puncture is lower. Therefore, the liquid crystal pollution may be reduced and the liquid crystal puncture arises less.

In some embodiments, the height of the second sealing component 4 and the depth of the groove 21 are equal so that the second substrate 3 is in contact with the first sealing component 2 closely to prevent the liquid crystal from flowing into the gap between the first sealing component 2 and the second sealing component 3.

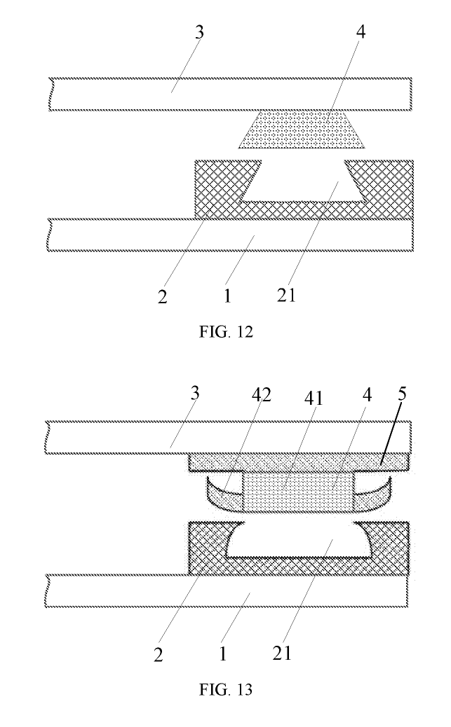

Here, referring to FIG. 11 or FIG. 12, the sidewall of groove 21 may be of an arc structure or an inclined plane structure.

The width of the top of the second sealing component 4 is greater than the width of the bottom of the second sealing component 4. For example, referring to FIG. 11, the side surface of the second sealing component 4 is of an arc structure that matches up with the side surface of the groove 21. Alternatively, for example, referring to FIG. 12, the side surface of the second sealing component 4 is of an inclined plane structure that matches up with the side surface of the groove 21. Alternatively, the second sealing component 4 comprises the square annular structure that is made up of four strip-shaped structures 41. Referring to FIG. 9, FIG. 9 illustrates the cross section of any one of the strip-shaped structures 41. The bottom of each strip-shaped structure 41 is fixed on the third substrate 3. The two side surfaces of each strip-shaped structure 41 are provided with the protruding parts 42 and the side of the protruding part 42 away from the second substrate 3 is flush with the top surface of the strip-shaped structure 41. The protruding part 42 is arranged to be flush with the top surface of the strip-shaped structure 41 to guarantee that the second sealing component 3 fits with the groove 21 tightly to reduce the gap in the groove after the second sealing component is embedded in the groove.

The material of the first sealing component 2 may a soft material. The material of the second sealing component 4 may be a soft material. The width of the opening of the groove 21 can be increased by external force (i.e., the opening of the groove 21 can be widened by external force). Then, the second sealing component 4 may be pressed to make it embedded in the groove 21.

In some embodiments, the width of the strip-shaped structures 41 and the width of the groove 21 are equal. Additionally, the material of the protruding part 42 is a fusible soft material.

When the second sealing component 4 is embedded into the groove 21, the protruding part 42 completely fills the space between the sidewall of the groove 21 and the strip-shaped structure 41.

In some embodiments, the second sealing component 4 may be fuse bonded with the sidewall of the groove 21.

The material of the protruding part 42 is a fusible material that may be fused when radiated by laser or when heated. Therefore, when the second sealing component 4 is embedded into the groove 21, the protruding part 42 may be fused by laser or heat source to make the second sealing component 4 be fuse bonded with the sidewall of the groove 21 so that the two parts are in contact with each other more closely. Thus, the second sealing component 4 fits with the groove 21 more tightly.

In some embodiments, referring to FIG. 13, the sealing component may further comprise: the third sealing component 5. The third sealing component 5 is arranged surrounding the second substrate 3;

The width of the top of the groove is less than or equals to the width of the third sealing component to prevent the gap between the groove and the third sealing component that may cause the liquid crystal to flow into the groove from being made. The width of the third sealing component 5 and the width of the second sealing component 2 are equal. The third sealing component 5 is fixed on the second substrate 3. The second sealing component 4 is fixed on the third sealing component 5. The display panel also has a display area and a non-display area. After the second sealing component 4 is embedded into the groove 21, the first sealing component 2, the second sealing component 4, and the third sealing component 5 form the annular structure surrounding the display area. The annular structure is made up of four strip-shaped structures and the cross section of each strip-shaped structure is rectangular.

The materials of the first sealing component, the second sealing component, and the third sealing component described above may be soft materials. The materials can be same or different. The soft materials may reduce the damage to the display panel and guarantee the distance between the first substrate and the second substrate after they are assembled. When external force is applied to any substrate of the display panel, the sealing structure that the soft material supports may provide the display panel with a certain buffer force.

In the embodiments of the present disclosure, since the structure of the first substrate and the structure of the second substrate are different, the manufacturing process for the sealing structure may vary. In the embodiments of the present disclosure, the manufacturing process for the sealing structure is exemplified by taking FIG. 13 as an example. For other manufacturing processes, this manufacturing process may be used as references. Exemplarily, the second sealing component 2 may be firstly formed on the body of the first substrate 1 to obtain the first substrate 1 as shown in FIG. 2. Then, the third sealing component 5 and second sealing component 2 are formed on the body of the second substrate 3 in sequence to obtain the second substrate 3 as shown in FIG. 5. Assuming the first substrate 1 is the lower substrate, the liquid crystal is instilled into the display area on the first substrate 1. After the instillation of the liquid crystal is completed, the second substrate 3 is buckled and arranged on the first substrate 1. External force is applied to the non-display area on the exterior side of either of the first substrate 1 and the second substrate 3 to widen the opening of the groove 21 so that the second sealing component 4 is embedded in the groove 21. Then laser or heat source is applied to the protruding part 42 of the second sealing component 4 to make the protruding part 42 be fused so that the second sealing component 4 may be fuse bonded with the sidewall of the groove 21 to further strengthen the sealing. After the second sealing component 4 is fuse bonded with the sidewall of the groove 21, the sealing procedure is completed.

In practice, the second substrate 3 may also be used as the lower substrate. In this case, the liquid crystal is instilled onto the second substrate 3. For the detailed process, the embodiment above may be used as references, which will not be repeated again in the embodiments of the present disclosure.

In the embodiments of the present disclosure, since the first sealing component is provided with a groove, the width of the bottom of the groove is greater than the width of the opening of the groove, and the width of the top of the second sealing component is greater than the width of the bottom of the second sealing component, after the liquid crystal is instilled onto the substrate, the second sealing component may be embedded into the groove and the first substrate and the second substrate may be assembled. Since the first sealing component and second sealing component fit with each other tightly through the method of embedding, the structure formed of the first sealing component and the second sealing component is not easy to be thrust and broken by the liquid crystal, thereby improving the binding strength. In addition, the first sealing component and the second sealing component on the two substrates are of solid structures when they are in contact with the liquid crystal. Compared to the traditional colloidal structure, solid structure pollutes the liquid crystal less and the possibility of liquid crystal puncture is lower. Therefore, the liquid crystal pollution is reduced and the liquid crystal puncture arises less.

The embodiments of the present disclosure provide a display panel. The display panel comprises any type of sealing structure provided in embodiment 1.

In embodiments of the present disclosure, since the first sealing component of the sealing structure of the display panel is provided with a groove, the width of the bottom of the groove is greater than the width of the opening of the groove, and the width of the top of the second sealing component is greater than the width of the bottom of the second sealing component, after the liquid crystal is instilled onto the substrate, the second sealing component may be embedded into the groove and the first substrate and the second substrate may be assembled. Since the first sealing component and second sealing component fit with each other tightly through the method of embedding, the structure formed of the first sealing component and the second sealing component is not easy to be thrust and broken by the liquid crystal, thereby improving the binding strength between the two substrates. In addition, the first sealing component and the second sealing component on the two substrates are of solid structures when they are in contact with the liquid crystal. Compared to the traditional colloidal structure, solid structure pollutes the liquid crystal less and the possibility of liquid crystal puncture is lower. Therefore, the liquid crystal pollution is reduced and the liquid crystal puncture arises less.

The embodiments of the present disclosure provide a display apparatus. The display apparatus comprises the display panel provided in the above embodiment.

In the embodiments of the present disclosure, the display apparatus comprises the display panel. The display panel comprises the sealing structure. Since the first sealing component of the sealing structure is provided with a groove, the width of the bottom of the groove is greater than the width of the opening of the groove, and the width of the top of the second sealing component is greater than the width of the bottom of the second sealing component, after the liquid crystal is instilled onto the substrate, the second sealing component may be embedded into the groove and the first substrate and the second substrate may be assembled. Since the first sealing component and second sealing component fit with each other tightly through the method of embedding, the structure formed of the first sealing component and the second sealing component is not easy to be thrust and broken by the liquid crystal, thereby improving the binding strength between the two substrates. In addition, the first sealing component and the second sealing component on the two substrates are of solid structures when they are in contact with the liquid crystal. Compared to the traditional colloidal structure, solid structure pollutes the liquid crystal less and the possibility of liquid crystal puncture is lower. Therefore, the liquid crystal pollution is reduced and the liquid crystal puncture arises less.

The above display apparatus may be a liquid crystal panel, electronic paper, a mobile phone, a tablet computer, a TV set, a display device, a laptop, a digital photo frame, a navigator or any other products or parts with display functionality.

Other embodiments of the present disclosure can be available to those skilled in the art upon consideration of the specification and practice of the invention disclosed herein. The present application is intended to cover any variations, uses, or adaptations of the present disclosure following general principles of the present disclosure and include the common general knowledge or conventional technical means in the art without departing from the present disclosure. The specification and examples can be shown as illustrative only, and the true scope and spirit of the disclosure are indicated by the following claims.

Understandably, this disclosure is not limited to the precise constructions described above and shown in the enclosed drawings, and various modifications and changes may be made without departing from the scope thereof. The scope of the present disclosure can be limited only by the appended claims.

What is claimed is:

1. A substrate, comprising a display area and a non-display area, wherein the non-display area is provided with a first sealing component;
the first sealing component comprises a groove arranged surrounding the display area, and a width of a bottom of the groove is greater than a width of an opening of the groove.

2. The substrate of claim 1, wherein a sidewall of the groove is of an arc structure or an inclined plane structure.

3. The substrate of claim 1, wherein a material of the first sealing component is a soft material.

4. The substrate of claim 1, wherein the first sealing component comprises a square annular structure that is made up of four strip-shaped structures, a bottom surface of each strip-shaped structure is fixed on the non-display area of the substrate, each strip-shaped structure is provided with a strip-shaped groove, and the four strip-shaped grooves are communicated to form the groove.

5. A substrate, comprising a display area and a non-display area, wherein the non-display area is provided with a second sealing component, the second sealing component is arranged surrounding the display area;
a width of a top of the second sealing component is greater than a width of a bottom of the second sealing component, and the bottom of the second sealing component is closer to the non-display area than the top of the second sealing component is.

6. The substrate board of claim 5, wherein a material of the second sealing component is a soft material.

7. The substrate of claim 5, wherein the second sealing component comprises a square annular structure that is made up of four strip-shaped structures and a bottom surface of each strip-shaped structure is fixed on the non-display area of the substrate.

8. The substrate of claim 7, wherein two side surfaces of the each strip-shaped structure are provided with protruding parts.

9. The substrate of claim 8, wherein a side of the protruding part that is away from the substrate is flush with a top surface of the strip-shaped structure.

10. The substrate of claim 7, wherein the display area is a square area and a figure of an inner boundary of the square annular structure and a figure of an outer boundary of the display area are similar.

11. The substrate of claim 8, wherein a material of the protruding parts is a fusible soft material.

12. The substrate of claim 5, wherein two side surfaces of the second sealing component are of arc structures or inclined plane structures.

13. A sealing structure of a display panel, comprising a first substrate and a second substrate, wherein both the first substrate and the second substrate are provided with display areas and non-display areas;
the non-display area of the first substrate is provided with a first sealing component;
the first sealing component comprises a groove arranged surrounding the display area of the first substrate, and a width of a bottom of the groove is greater than a width of an opening of the groove;
the non-display area of the second substrate is provided with a second sealing component, the second sealing component is arranged surrounding the display area of the second substrate;
a width of a top of the second sealing component is greater than a width of a bottom of the second sealing component, and the width of the top of the second sealing component is greater than the width of the opening of the groove, the bottom of the second sealing component is closer to the non-display area of the second substrate than the top of the second sealing component is; and
the second sealing component is embedded in the groove.

14. The sealing structure of claim 13, wherein a height of the second sealing component equals to a depth of the groove.

15. The sealing structure of claim 13, wherein the second sealing component is fuse bonded to a sidewall of the groove.

16. The sealing structure of claim 13, further comprising a third sealing component, wherein the third sealing component is arranged surrounding the display area of the second substrate; and
a width of the third sealing component equals to the width of the first sealing component, the third sealing component is fixed on the second substrate, and the second sealing component is fixed on the third sealing component.

17. The sealing structure of claim 16, wherein the width of the top of the groove is less than or equals to the width of the third sealing component.

18. The sealing structure of claim 16, wherein a material of the third sealing component is a soft material.

19. A display panel, comprising the sealing structure of claim 13.

20. A display apparatus, comprising the display panel of claim 19.
